(19) United States
(12) Patent Application Publication
(10) Pub. No.: US 2025/0305353 A1
(43) Pub. Date: Oct. 2, 2025

(54) ARCHITECTURAL INTERIOR DOOR CONSTRUCTION

(71) Applicant: ISOSTRUC LLC, Mint Hill, NC (US)

(72) Inventor: Stephen Edward CAVENDER, Mint Hill, NC (US)

(21) Appl. No.: 19/236,702

(22) Filed: Jun. 12, 2025

Related U.S. Application Data
(62) Division of application No. 18/414,123, filed on Jan. 16, 2024, now abandoned.

(51) Int. Cl. E06B 3/70

(52) U.S. Cl. CPC E06B 3/7015; E06B 2003/7023; E06B 2003/7046

(57) ABSTRACT

A door comprising a molded core formed of a rigid foam material, having rigid reinforcing inserts affixed to the molded core.

### CROSS REFERENCE TO RELATED APPLICATION

This application is a divisional of U.S. application Ser. No. 18/414,123, filed Jan. 16, 2024, the contents of which are incorporated herein by reference.

### FIELD OF THE INVENTION

This invention pertains to interior door construction, and more particularly to an interior door construction that is essentially free of wood or engineered wood products.

### BACKGROUND

Wood has been one of the most commonly used building materials since the beginning of human history. Wood has good compressive and tensile strength which makes it suitable for many construction applications. Wood is readily available and its relatively low cost, and ease of machining makes wood a material of choice for use in building doors.

Doors are a daily use product providing security and privacy. For many years, exterior doors have been fabricated from solid wood in order to provide adequate strength, insulation, and weathering characteristics as well as an “attractive” appearance. US632700A to Cronin, provides a description of how they were made. Because of the cost of fabricating solid slab doors, and the need to find wood slabs which were relatively free from imperfections, companies turned to making doors which employed veneers adhered to a core of less expensive wood. These veneers were then fully or partially replaced by metal skins for added endurance, but at the expense of aesthetics.

Interior doors have far fewer structural demands than exterior doors since interior doors are not subjected to the elements, e.g., rain and snow, temperature and humidity extremes, or excessive sunlight. Also, interior doors do not require strength against break-ins. Thus, interior doors have a lower cost as a driver in their development. As a consequence, interior doors may be formed of a wooden skeleton covered on each side with a facia. See for example, U.S. Pat. No. 3,083,745A to MacDonald in which there is described a door construction comprising a pair of stiles and top and bottom rails, defining a rectangular frame, with a pair of opposed facia skins mounted on this frame enclosing an interior space. Such a design has been widely and successfully used for a substantial period of time.

While wood is attractive from an architectural standpoint, wood has several detriments. Wood has a tendency to warp, rot, and mold, pests, e.g., may be attacked by termites and carpenter ants, and is combustible. Additionally, being a natural product, wood is inconsistent, making wood building a poor modern-day construction material, not to mention its controversial deforestation mandate. Doors formed of wood have a potential for splitting and cracking in addition to long-term moisture absorption resulting in warping and swelling.

Although the use of metal alloys, concrete and plastics have brought significant advances in construction, wood has never lost its consumer appeal. Thermal and acoustic insulation and safety assets such as fire barrier/retardancy are routinely overlooked to accommodate wood-based door construction. Even to this day, for accepted aesthetics, non-wood replacement parts are made to have a textured look like wood.

Some of wood's detriments have been addressed through developments in engineered wood and the use of alternative materials such as aluminum and fiberglass in manufacturing doors, but at a significant increase in cost.

Occasionally metals, primarily aluminum, have been used for forming door stiles and rails. However, wood and engineered wood still dominate as a primary material for forming doors.

Wood veneers and metal panels are used as facia, but most door panels in present use are made from molded fiberglass reinforced polyester, or engineered wood such as Masonite. Also, polyvinylchloride (PVC), polycarbonate, and acrylic-capped acrylonitrile butadiene styrene (ABS) have been utilized as door facias for niche applications. These molded panels usually are formed with contours to simulate the texture and appearance of fully wooden doors.

For forming solid core doors, various materials including foamed synthetic resins or polymer honeycomb shaped material have been used between a wooden skeleton and facia panels for a more solid, “high quality” look and feel. Foamed cementitious core materials also have been used for superior fire retardancy, while polystyrene has been used for economy. Foam, either spray applied or incorporated as cut panels also have been used in the enclosed space between a wooden frame and facia panels.

Despite advances in materials, door design basics have remained essentially unchanged, that is a pair of wooden stiles and top and bottom wooden rails, defining a rectangular frame, with a pair of opposed facia skins mounted on the frame enclosing an interior space.

Generally, plastic products have certain inherent properties which make them potentially attractive for use as wood replacements. Plastics have superior resistance to weathering, fungi and pest attacks, reduced shrinkage and swelling produced by variations in temperature and humidity and are readily shaped by molding or mechanical treatment. In addition, quality control, i.e., consistent quality standards are repeatedly and routinely met providing a far more consistent product with less waste.

Rigid polyisocyanurate/polyurethane foam technology has advanced. Rigid polyisocyanurate/polyurethane foam possesses properties typical of other plastics but also provides superior thermal and acoustical insulating properties, and fire retardancy. These properties along with lightweight and rigidity make it a very good material for incorporating into interior doors. This material starts as two liquid components that are mixed together and then poured into a mold. The mixture foams filling the mold to produce a solid profile with surface contours and texturing that satisfies door appearance demands. The door may consist of a single molded part, or two essential mirror image parts adhered together to produce the desired final door shape, size and appearance.

However, a major disadvantage of rigid polyisocyanurate/polyurethane foam is that it does not possess sufficient structural integrity to hold screws for fastening hinges or other fixtures, such as handles, locks, and door closures. In accordance with the present invention, we provide strategically placed structural inserts in a mold prior to pouring the liquid components of the foam. Structural inserts may be formed of rigid/semi rigid plastic material, designed to securely hold screws, for door handles, and locks, etc.

In one embodiment the structural inserts are located on a hinge edge of the door.

In another embodiment, the structural inserts are located on the handle/lock edge of the door.

In yet another embodiment, the rigid foam profile may be contoured to accommodate an external rigid stile designed to form an edge of the door for attachment of hinges. This stile may be glued to the rigid foam door or may be attached via screws into the pre-incorporated inserts or may be incorporated as part of the molding process.

In yet another embodiment, the rigid foam profile may be contoured to accommodate an external rigid rail configured to run along a bottom of the door. This stile may be glued to the rigid foam door or may be attached via screws into the pre-incorporated inserts or incorporated in the molding process.

In still yet another embodiment, the rigid rail is configured to run along a top of the door.

In yet another embodiment, the door is coated with a durable paint or coating forming a puncture and scuff resistance surface.

### BRIEF DESCRIPTION OF THE DRAWINGS

Further features and advantages of the present invention will be seen from the following detailed description, taken in conjunction with the accompanying drawings, wherein lines numerals depict like parts, and wherein:

FIG. 1 is a perspective view of a door formed in accordance with a first embodiment of the present invention;

FIG. 1A and FIG. 1B are enlarged perspective views of examples of rigid/semi-rigid insert elements of the door of FIG. 1;

FIG. 2 is a flow diagram of a manufacturing process for forming the door of FIG. 1;

FIG. 3 is a perspective view of a door in accordance with a second embodiment of the present invention;

FIG. 4 is a perspective view of still yet another embodiment of the present invention; and

FIG. 5 is a perspective view of a door made in accordance with yet another embodiment of the present invention.

### DETAILED DESCRIPTION OF THE INVENTION

As used herein the term “core” is intended to include the entirety of the rigid foam portion of the door excluding the inserts or rigid externally attached hardware.

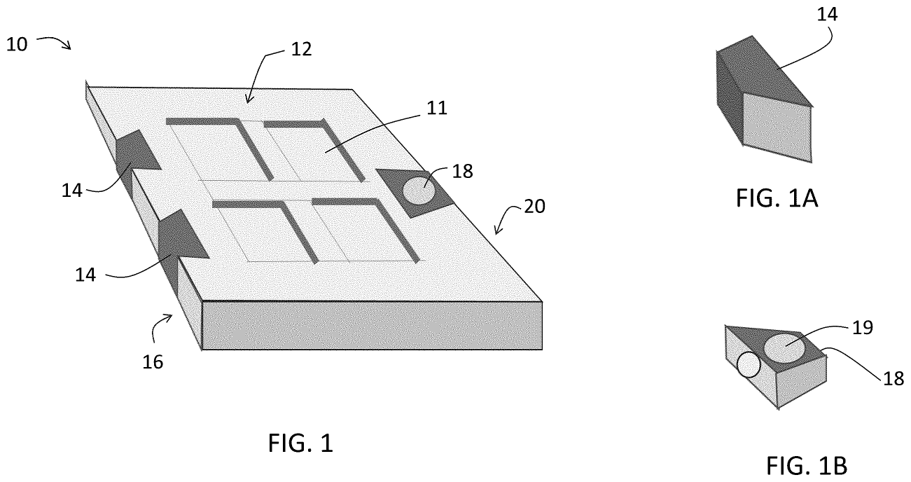

Referring to FIG. 1, there is illustrated a door 10 comprising a solid rectangularly shaped foam door comprising a main core 12. Core 12, which makes up the bulk of the door, is formed of a rigid foam material such as polyisocyanurate/polyurethane foam and may be textured or shaped 11. Door 10 includes rigid/semi-rigid inserts 14 on hinge edge 16 of the door, and a handle accommodating insert 18 on the handle edge 20 of the door. Inserts 14 and 18 are formed of a structural material such as wood, metal or more preferably rigid/semi-rigid plastic material having sufficient structural strength to securely hold screws to fix hinges (not shown) to the hinge side of the door, and in the case of insert 18, contains a hole 19 to accommodate a door handle and/or lock mechanism.

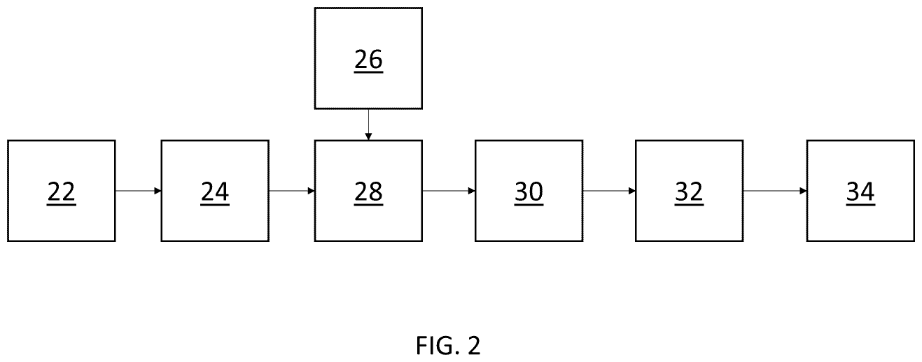

Referring to FIG. 2, door 10 is formed as follows:

A mold (not shown) is provided in a first step 22.

Reinforcing inserts 14 and 18 are placed in position in the mold in step 24. Polyhydroxy alcohol and diisocyanate components are premixed in a mixing step 26 and poured into the mold in a mold filling step 28, the mold may be closed in a step 30, and the mixture allowed to foam and cure. The cured rigid foam with incorporated inserts is then removed from the mold in step 32, and a door formed primarily of polyisocyanurate/polyurethane foam, and having reinforcing inserts 14 and 18 molded in situ results. The door is then coated with a durable coating such as a polyaspartic or epoxy to provide protection, washability, durability, and color at a coating step 34.

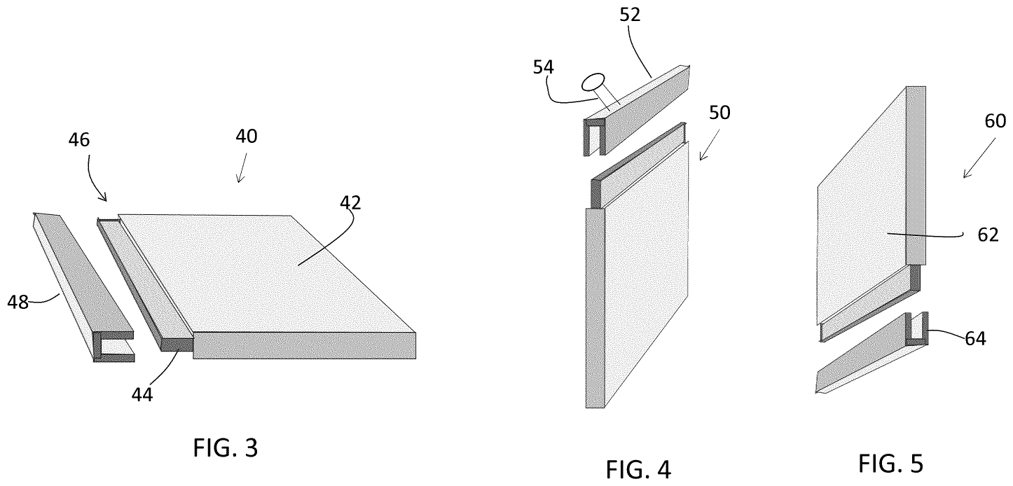

Referring to FIG. 3 there is illustrated another embodiment of the invention. In the FIG. 3 embodiment, a rigid foam door 40 comprises a main core 42. Main core 42 formed with a tongue or tang 44 running a length of a hinge side 46 of the door. A rigid stile 48 formed of wood, metal or a rigid plastic material is fixed over tongue or tang 44 by gluing in place. Alternatively, door 40 may be formed with rigid reinforcing stile 48 molded in situ following the process of FIG. 2.

FIG. 4 illustrates another embodiment, in which the top of door 50 is provided with a rigid reinforcing rail 52 formed of a wood, metal or a rigid plastic. As in the case of the FIG. 3 embodiment, the reinforcing rail 52 may be glued to the main core or molded in situ or fastened by screwing into inserts in the rigid foam core. Door 50 is designed for hanging as a rolling door. Rollers 54 or a closure fixture may then be fixed to the door through the rigid rail at the top of the door.

Referring to FIG. 5 in yet another embodiment, door 60 is formed of a polyisocyanurate/polyurethane foam forming a main core 62 and having a rigid kick plate 64 formed on the bottom of the door. Kick plate 64 may be formed of a rigid plastic material, metal, or wood, and fixed to the main body of the door as described above relative to FIGS. 3 and 4.

A feature and advantage of the present invention is that the polyisocyanurate foam used for forming the main section of the door has a solid heavy door feel yet is remarkably lightweight for ease of handling and installation. Another feature is that the door may be formed with intricate surface patterns which are formed during the molding process.

The above depiction represents, but is not meant to be limited to, an example of a molded rigid foam door with inserts strategically placed to accept traditional screwed hardware.

Further, the molded door can be contoured to fit into an external wood-free stile designed for attachment of hinges or an external wood-free rail designed for attachment of hardware for sliding or folding doors.

The above depiction represents, but is not limited to, an example of a rigid foam door with an external wood-free stile or rail.

Various changes may be made without departing from the spirit and scope of the invention. For example, a rigid insert 70 may be molded into a top of door 10, for affixing a door closure 72. Still other changes are possible.

Although this type of rigid foam possesses enough structural integrity to produce a “solid feel” door, the door may still be prone to denting more easily than a standard door formed of fiberglass or Masonite skins. As a further embodiment of this invention a durable coating is applied over the surface of the rigid foam to provide such protection and durability.

1. A method for forming a frameless door formed of a rigid foam material consisting of polyisocyanurate/polyurethane rigid foam, comprising the steps of:
(a) providing a mold;
(b) placing at least two reinforcing inserts adjacent one edge of the mold within the mold and at least one reinforcing insert adjacent an opposite edge of the mold within the mold;
(c) providing a mixture of a polyhydroxy alcohol and a diisocyanate and pouring the mixture into the mold;
(d) allowing the mixture to foam and cure in the mold, wherein a frameless door having in situ reinforcing inserts is formed;
(e) removing the frameless door formed in step (d) from the mold; and
(f) coating surfaces of the frameless door from step (e) with a durable coating.

2. The method of claim 1, wherein the in situ molded reinforcing inserts are configured to accommodate hinges.

3. The method of claim 1, wherein the in situ molded reinforcing inserts are configured to accommodate a door handle and/or door lock.

4. The method of claim 1, wherein the in situ molded reinforcing inserts are configured to accommodate hanging rollers or a kick plate.

5. The method of claim 1, wherein the frameless molded door is contoured to accommodate an external rigid stile or rail.

6. The method of claim 1, wherein the protective coating comprises a paint.

7. The method of claim 1, wherein the protective coating comprises a polyaspartic or an epoxy.
